(19) United States
(12) Patent Application Publication
(10) Pub. No.: US 2006/0077182 A1
(43) Pub. Date: Apr. 13, 2006

(54) Methods and systems for providing user selectable touch screen functionality

(76) Inventor: Peter C. Studt, San Ramon, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 10/961,126

(22) Filed: Oct. 8, 2004

(51) Int. Cl. G09G 5/00

(52) U.S. Cl. 345/173

(57) ABSTRACT

A method is provided that affords user selectable functionality through a touch screen. The method includes defining active areas on the touch screen, each active area being associated with at least one functional set. According to the method, input actions are detected at the touch screen with each input action being defined by at least one of a touch event and a release event occurring at the touch screen. The method determines when a series of at least three input actions occurs within a common active area and produces an operation command based on the number of input actions in the series and upon the active area in which the series of input actions occur. In accordance with an alternative embodiment, a touch screen system is provided having user selectable functionality. The touch screen system includes a display screen that presents information indicative of an active area. The active area is associated with at least one functional set. The touch screen system further includes a sensor unit located proximate to the touch screen for sensing at least one of a touch event and a release event. The touch screen further includes a processor that determines when a series of at least three input actions occurs within a common active area. The processor produces an operation command based on a number of the input actions in the series and based upon the common active area.

### BACKGROUND OF THE INVENTION

The present invention relates generally to methods and systems for providing user selectable functionality through a touch screen, such as the functionality selectable by a computer mouse.

Today, touch screens are used for a wide variety of applications and in numerous fields, such as in retail applications, data entry businesses, medical applications, manufacturing environments and the like. In general, systems that utilize touch screens include a display operated in combination with a sensing apparatus configured to detect input actions proximate to the display. An input action may be initiated by a finger or a hand of a user, a physical instrument, and the like. The display typically presents windows or views containing a configuration of active areas, such as buttons, the numerals of a keypad, graphical icons, an alphabetic keyboard, and the like. When the sensors detect the occurrence of an input action, the action is correlated with an active area presented on the display. Each active area is associated with at least one function or set of functions. For example, the active areas may be presented as buttons corresponding to the numerals 0-9. Another example may include active areas presented as buttons associated with an “enter” function, a “return” function, the mathematical operations functions (+, −, ÷, ×), alphabetic letters, and the like.

Conventional touch screen systems have also provided the user with the ability to perform certain operations of a conventional computer mouse, such as the single or double click of the left button on the mouse. The operation of the computer mouse right button has been provided on touch screens by displaying an icon representative of a computer mouse on the display. After, the computer mouse icon is touched, the next input action is processed as a computer mouse right button click. When the user touches the computer mouse icon, the icon may become shaded to inform the user that the next input action detected on the touch screen will be processed as a computer mouse right click operation.

However, existing touch screen systems that afford the operations of the computer mouse have met with certain limitations. On conventional touch screen systems the user may inadvertently contact the computer mouse icon, without intending to do so, and not notice such contact. Consequently, the next contact upon the screen is processed as a computer mouse right click when the user did not intend such operation. Also, when the user does intentionally touch the computer mouse icon, the user's next touch may be in the wrong active area as the user's finger moves between the computer mouse icon and another active area. Hence, while the user intended to initiate a computer mouse right click, the operation may be carried out in connection with the wrong active area.

A need remains for methods and systems for providing reliable and accurate user selectable functionality through a touch screen.

### BRIEF SUMMARY OF THE INVENTION

A method is provided that affords user selectable functionality through a touch screen. The method includes defining active areas on the touch screen, each active area being associated with at least one functional set. According to the method, input actions are detected at the touch screen with each input action being defined by at least one of a touch event and a release event occurring at the touch screen. The method determines when a series of at least three input actions occurs within a common active area and produces an operation command based on the number of input actions in the series and upon the active area in which the series of input actions occurs.

In accordance with at least one embodiment, the operation command corresponds to the operation associated with a right click on a computer mouse. Optionally, different first and second functional sets are assigned to the common active area which correspond to first and second operation commands, respectively.

Optionally, the detecting operation may include sensing the touch event based on an object contacting the touch screen or when an object is positioned proximate to, but not contacting, the touch screen.

Optionally, the method may include initiating a timer when a touch event is detected, wherein a release event must occur within a predetermined time interval to constitute a valid input action. As a further option, the method may include determining when first, second and third input actions occur within pre-defined time intervals of one another.

In accordance with an alternative embodiment, a touch screen system is provided having user selectable functionality. The touch screen system includes a display screen that presents information indicative of an active area. The active area is associated with at least one functional set. The touch screen system further includes a sensor unit located proximate to the touch screen for sensing at least one of a touch event and a release event. The touch screen further includes a processor that determines when a series of at least three input actions occurs within a common active area. The processor produces an operation command based on a number of the input actions in the series and based upon the common active area.

### BRIEF DESCRIPTION OF THE DRAWINGS

FIG. 1 illustrates a block diagram of a touch screen system formed in accordance with an embodiment of the present invention.

FIG. 2 illustrates a block diagram of the functional modules implemented by a touch screen control module in accordance with an embodiment of the present invention.

FIG. 3 illustrates a block diagram of select functions that may be performed during initialization.

FIGS. 4A-4D illustrate a logic flow diagram for providing user selectable functionality through a touch screen in accordance with an embodiment of the present invention.

### DETAILED DESCRIPTION OF THE INVENTION

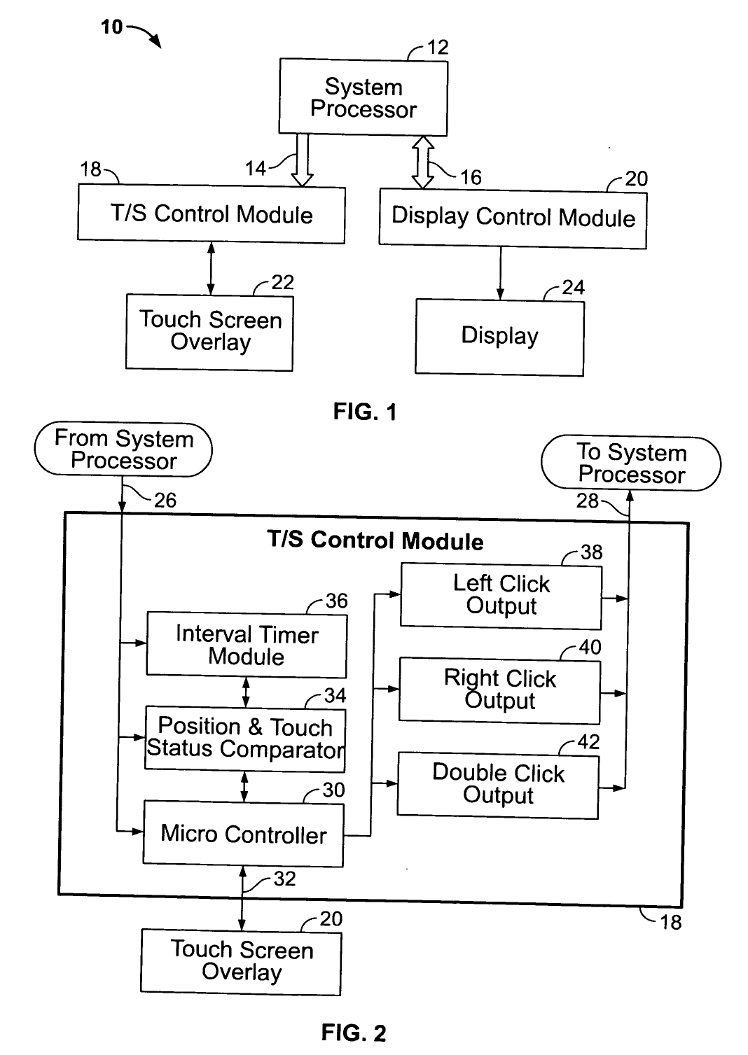

FIG. 1 illustrates a touch screen system 10 formed in accordance with an embodiment of the present invention. The touch screen system 10 includes a system processor 12 which performs overall control of the touch screen system 10, including implementation of applications for various industries. The system processor 12 communicates over a bus or bi-directional links 14 and 16 with a touch screen control module 18 and a display control module 20, respectively. The touch screen control module 18 transmits control signals to and receives sensor signals from a touch screen overlay 22.

By way of example, the control signals transmitted from the touch screen control module 18 may include timing signals, ultrasound drive transmissions, optical drive signals and the like. The sensor signals supplied from the touch screen overlay 22 may represent touch events, release events, streaming/drag touch events and the like. A touch event occurs when a user's hand or finger or an instrument contacts a touch sensitive pad or is placed in sufficiently close proximity to the touch screen overlay to be detected by the sensing mechanism (e.g. optical sensors, ultrasound sensors and the like). A release event occurs when the user's hand or finger or an instrument is removed from a position in contact with, or close proximity to, the touch sensitive pad or touch screen overlay. A drag event occurs when, after a touch event and before a release event, the user's hand or finger or the instrument is held in contact or close proximity with the touch sensitive pad or touch screen overlay and moved across the surface of the touch sensitive pad or touch screen overlay. The sensor signals also include coordinate information indicative of the position at which the touch event, drag event or release event occurred. The information may constitute a pixel location, a row and column combination, an X and Y coordinate combination within the coordinate system of the touch screen overlay 22 and the like.

The display control module 20 controls presentation of graphical information on the display 24. The graphical information may represent one or more windows or screens having associated therewith one or more active areas. Active areas may be graphically represented as buttons, icons, drop-down menus, text/numeric entry boxes and the like. The display 24 may represent, among other things, a personal digital assistant, a point of sale terminal, an automated teller machine, a user interface of a medical system, and the like.

The system processor 12 coordinates operation between the touch screen control module 18 and the display control module 20 such that the graphical areas presented on the display 24 are defined as active areas by the system processor 12 by correlating the active area with one or more functions. Examples of functions include, among other things, entry of a numeral or letter corresponding to a button on a key pad, entry of an enter-command, a shift command, a control command and the like. Other examples of functions include the functions performed upon receipt of operation commands from a computer mouse when performing a left single click, left double click or right click operation.

In accordance with at least one exemplary implementation, the display control module 20 may present on display 24 icons, a toolbar containing buttons, folders and the like. For example, when the display 24 is controlled to present a window associated with an e-mail package, the window may include a toolbar containing options such as “file”, “edit”, “view”, “tools”, and the like. In addition, the window may be bifurcated into a folder list along one side and a listing of the individual e-mail stored within a currently selected folder along the other side. Each individual folder, e-mail entry, tool bar button and the like may have one or more functions associated therewith. A single click operation (e.g., touching and/or releasing the left button on the computer mouse) may initiate different operations depending upon which item is selected. When a single click operation is performed on an individual e-mail item in a list, the item is highlighted to indicate that the e-mail item has been selected. Hence, the function associated with the single click operation and the e-mail item is to “highlight” the e-mail item. When a single click operation is performed upon a folder entry, the folder entry is highlighted and a listing is generated itemizing the e-mail stored within the selected folder. Hence, two functions are associated with the single click operation and the folder entry, namely to highlight the folder and open the folder. When a single click operation is performed upon a button on the toolbar, a drop down menu is presented with various follow-up functions. Hence, the function generates a drop-down menu to present follow-up functional options.

When a double click operation (e.g., consecutively touching and/or releasing the left button on the computer mouse twice within a relatively short period of time) is selected for an individual e-mail entry, the function of opening the e-mail entry is performed. The buttons on the toolbar may not necessarily have unique double click functions associated therewith. The folder entries within the e-mail folder list may have double click functions associated therewith, such as exhibiting subfolders within the folder list or closing previously displayed subfolders from the displayed folder list.

The system processor 12 may also assign right click functions to individual e-mail entries (e.g., when touching and/or releasing the right button on the computer mouse). When a right click operation is performed with respect to an e-mail entry, a drop-down menu is presented displaying functions that may be performed in connection with the selected e-mail entry (e.g., open, print, reply, forward, view attachments, and the like).

FIG. 2 illustrates a block diagram of the functional modules within the touch screen control module 18 that distinguish and interpret touch and release events and produce therefrom operation commands formatted to be understood by the system processor 12. The touch screen control module 18 receives inputs over line 26 from the system processor 12 and outputs signals over line 28 to the system processor 12. Within the touch screen control module 18, a micro-controller 30 directly communicates over a bi-directional link 32 with the sensors of the touch screen overlay 20. The touch screen control module 18 includes a position and touch status comparator module 34 and an interval timer module 36. The comparator module 34 and timer module 36 are not generally discrete hardware components, but instead represent functional modules carried out by or under the direction of the micro-controller 30.

The touch screen control module 18 outputs operation commands, such as a left click or left button down output 38, a right click or right button output 40, and a double left click output 42. The outputs 38, 40 and 42 represent operation commands formatted based upon the input parameters of the system processor 12. The outputs 38, 40 and 42 may be formatted to resemble the operation commands output by a computer mouse to enable the touch screen control module 18 and touch screen overlay 22 to be easily implemented with conventional off-the-shelf computer systems, such as personal computers, controlled by off-the-shelf operating systems. As explained below in more detail, the micro-controller 30 identifies touch events (e.g., when a finger or instrument contacts the touch screen overlay 20). The micro-controller 30 also identifies drag events and release events (e.g., when a finger or instrument is removed from the surface of the touch screen overlay 20). The micro-controller 30, in addition to identifying the touch, drag and release events, also identifies the position at which the associated touch, drag or release event occurred. The type/status of event and the location of the event are processed by the controller 30 in cooperation with the comparator module 34 and timer module 36 to identify input actions.

Optionally, the system processor 12 may perform one or more of the functions associated with the internal timer module 36, position and touch status comparator 34 and outputs 38, 40 and 42. Further, the touch screen control module 18 and system processor 12 may both perform the same function in parallel, such as associated with one or more of the position and touch status comparator 34, internal time module 36, and outputs 38, 40 and 42.

Line 26 enables the system processor 12 to modify and update the interval timers, as well as other control criteria, the size and shape of each click function box, the functions associated with each function box and the like. A function box represents a bordered area, in which a series of touch, drag and/or release events should be sensed to constitute a valid single click, double click or right click input action.

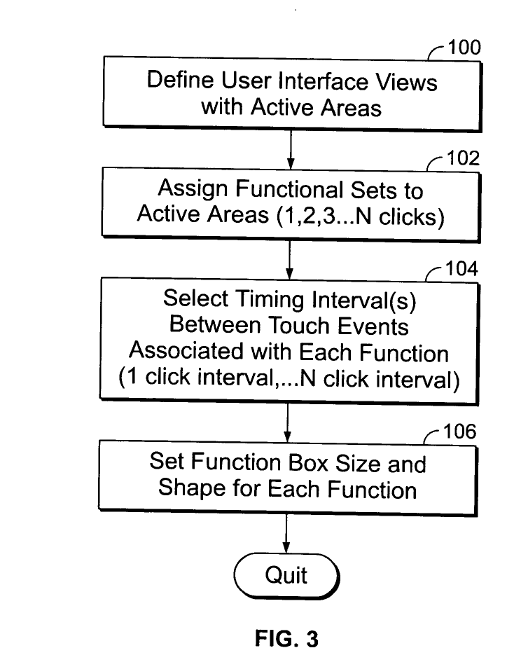

FIG. 3 illustrates a block diagram of select functions that may be performed during initialization. At step 100, the system processor 12 may obtain or define the user interface views to be presented during a particular application, as well as the active areas within each view. Examples of active areas include icons, buttons on a toolbar, alpha numeric keys, items listed in menus, and the like. At step 102, the system processor 12 assigns functions to the active areas. The functions associated with a particular active area represent a functional set. For example, one button on a task bar may have a first functional set associated therewith when a single left click occurs, a second functional set associated therewith when a double left click occurs and a third functional set associated therewith when a right click occurs. It is understood that every active area need not include the same number of functions nor the same functions.

At step 104, one or more timing intervals are selected that are associated with each single, double and right click input action. A timing interval may represent the maximum time between consecutive touch events, the time between a touch event and a subsequent release event, the time between a first touch event and a third release event, the time between consecutive release events and the like. As one example, three timing intervals may be selected, where the first timing interval corresponds to the maximum time between consecutive touch and release events to constitute a valid single click input action. As another example, a separate timing interval may be selected as the maximum time between first and second touch events associated with a valid double left click input action. A third timing interval may be selected to be used in connection with a right click input action. The timing interval associated with a right click input action may correspond to the maximum interval between the first and second consecutive touch events, and correspond to the maximum interval between the second and third consecutive touch events.

It is understood that the present implementation is not limited to the above examples, but instead other options may also be utilized, such as a double click of the right mouse button, a triple click of the left mouse button, a triple click of the right mouse button and the like. In addition, input actions may be defined entirely un-related to the operation of a computer mouse, such as the shift operation command upon a keyboard, the control operation command, the alt operation command and various combinations and permutations thereof, as well as others.

Returning to FIG. 3, at step 106, the system processor 12 sets the function box size and shape associated with each of the function boxes identifiable by the touch screen control module 18. The box size and shape associated with a single left click or button input action need not be the same as the box size and shape associated with a right click or button input action.

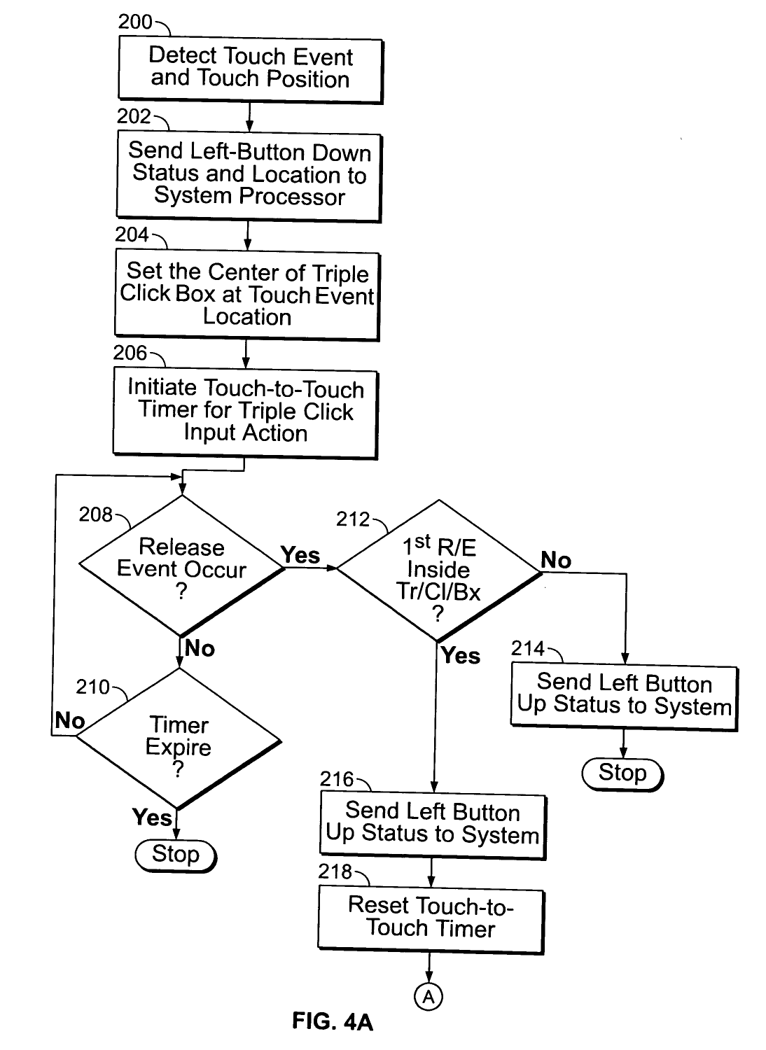

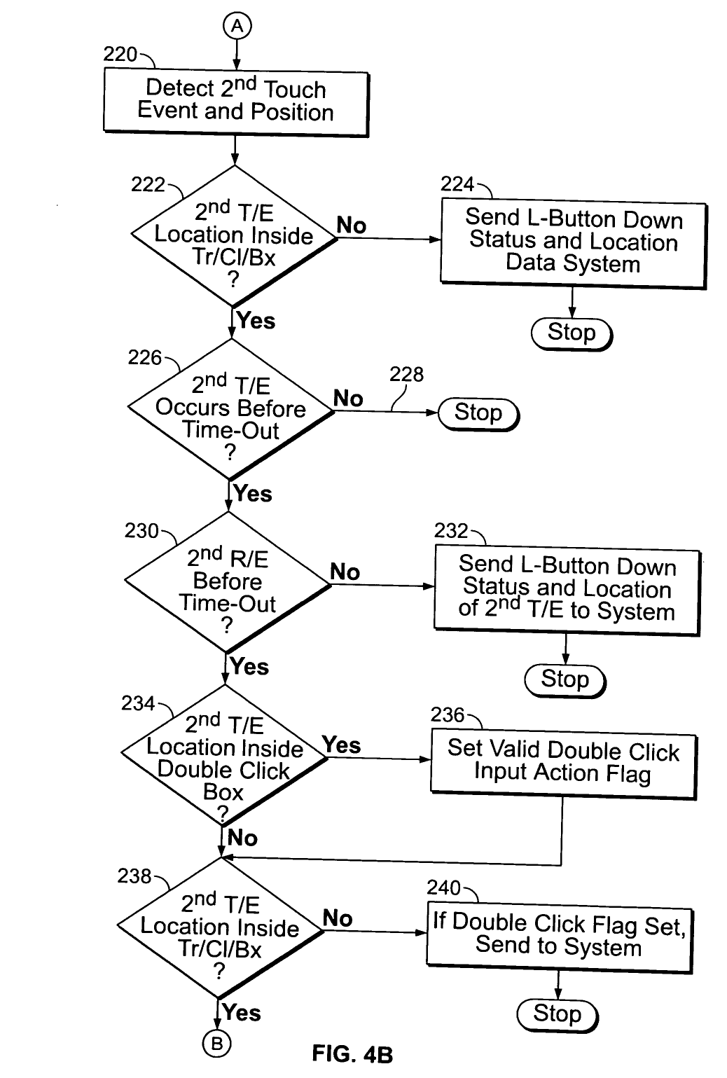

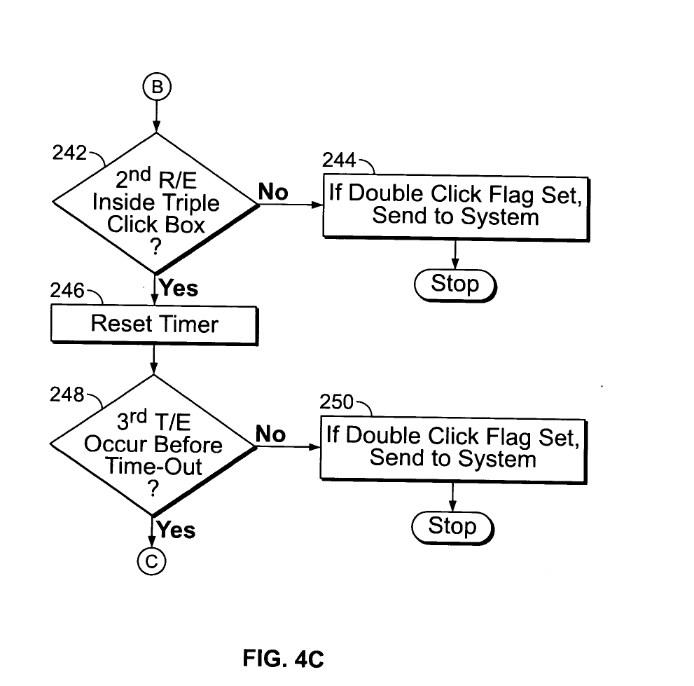

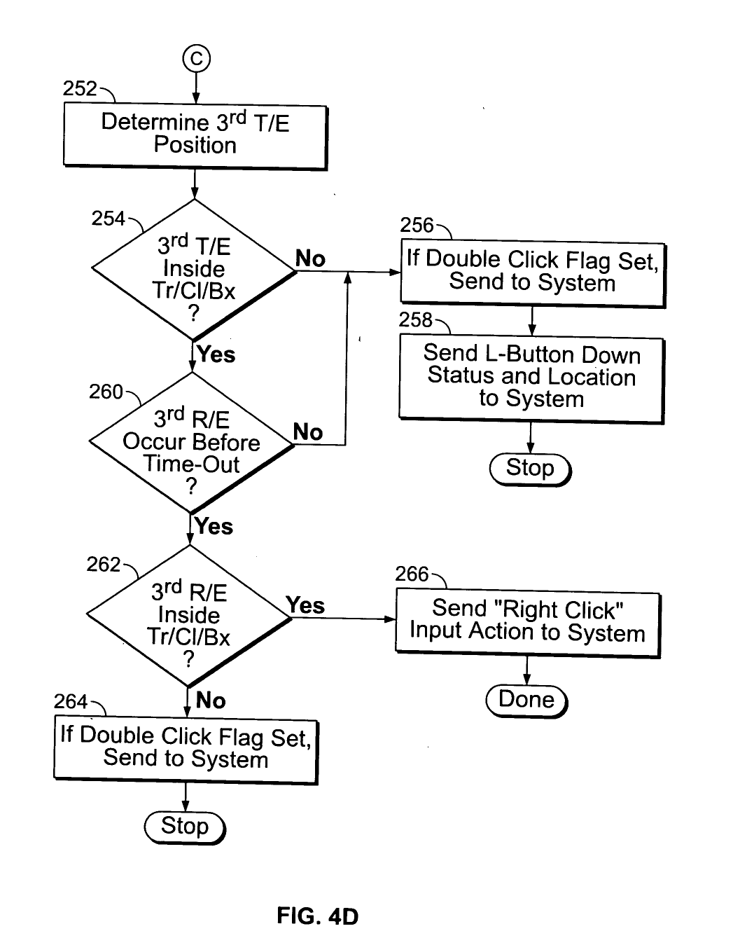

FIGS. 4A-4D illustrate a logic flow diagram to identify a triple touch or triple click input action. A triple click input action occurs when a user consecutively touches the touch screen overlay 22 three times in succession within predefined time intervals between each touch event, all within a common triple click box. Once the user “triple clicks” or triple touches a desired active area on the display 24, the touch screen control module 18 generates a right button output 40 (FIG. 2) to the system processor 12.

In FIG. 4A, operation begins at step 200, at which a first touch event (1^{st} T/E) is detected, along with the position at which the touch event occurred on the touch screen overlay 22. At step 202, the touch screen control module 18 generates a “left button down status” and the location of the touch event. The left button down status corresponds to a left click output 38 which is output to the system processor 12 (FIG. 2) as an operation command. At step 204, the touch screen control module 18 sets the center of a triple click box (Tr/Cl/Bx) at the location of the first touch event. The comparator module 34 (FIG. 2) utilizes the triple click box position set at step 204 in subsequent operations (as explained below) to determine whether subsequent touch and release events fall inside the triple click box. In this manner, the comparator module 34 determines whether subsequent touch and release events correspond to a valid triple click input action. In the event that subsequent touch and release events fall outside of the triple click box, the triple click identification operation is restarted.

At step 206, the interval timer within timer module 36 is initiated to monitor the touch-event-to-touch-event time. At step 208, it is determined whether a release event (R/E) has occurred. So long as no release event occurs, control passes to step 210, at which the timer module 36 is checked to determine whether the timer has expired or “timed out”. If the timer module 36 has timed out, it is determined that the preceding touch event does not constitute part of a valid triple click input action and processing is stopped and returned to step 200.

In the alternative, if at step 208 a first release event (1^{st} R/E) does occur prior to the timer module 36 timing out, flow passes to step 212, at which the position of the release event is analyzed to determine whether the release event coordinates are inside the triple click box (Tr/Cl/Bx). The comparator module 34 performs the analysis at step 212. When the first release event is not inside the triple click box, flow passes to step 214. At step 214, the touch screen control module 18 outputs a “left button up” status to the system processor 12 along line 28 (FIG. 2). After step 214, the search for a triple click input action is stopped and flow returns to the initial step 200.

Alternatively, if at step 212, the first release event is determined by the comparator module 34 to be inside the triple click box, flow passes to step 216 at which a “left button up” status is sent to the system processor 12. Following step 216, at step 218, the timer module 36 is reset to begin looking for the second touch event (2^{nd} T/E). Flow passes from step 218 in FIG. 4A to step 220 in FIG. 4B.

FIG. 4B illustrates the sequence carried out during the portion of the triple click validation process in which the second click is validated. At step 220, a second touch event is detected and the position of the second touch event is identified by the micro-controller 30 (FIG. 2). At step 222, the comparator module 34 determines whether the second touch event is located inside the triple click box. If no, flow passes to step 224 at which a “left button down” status (e.g., output 38) is sent to the system processor 12 along with location data identifying the position of the second touch event. Following step 224, the triple click validation process is stopped and flow returns to step 200.

If at step 222, the second touch event location is determined to be inside of the triple click box, flow passes to step 226. At step 226, the timer module 36 determines whether the second touch event occurs before the interval timer times out. If the second touch event occurs after the interval timer times out, flow passes along path 228 and the triple click validation process is stopped. Alternatively, if the second touch event occurs before the timer times out, flow passes to step 230 at which the timer module 36 next determines whether a second release event occurs before the timer 36 module times out. If a second release event occurs before the timer module 36 times out, flow passes to step 232. At step 232, a “left button down” status (e.g., output 38) is sent to the system processor 12 along with the location of the second touch event. Thereafter, the triple click validation process is stopped.

Alternatively, if at step 230, the second release event occurs before the timer times out, flow passes to step 234 at which the comparator module 34 determines whether the second touch event location is inside of a double click box. If the second touch event location is inside of the double click box, flow passes to step 236 and a flag is set denoting that a valid double click input action has been identified. The process of FIGS. 4A-4D continues because the current sequence of touch and release events may ultimately result in a valid triple click event, but at least as of step 236, a valid double click input action has been confirmed.

Continuing to step 238, it is determined whether the second touch event location is inside of the triple click box. The double click box and the triple click box may or may not have the same shape and size. If the second touch event is not located inside of the triple click box, flow passes to step 240 at which the flag associated with a valid double click input action is analyzed. If the double click flag is set (as in step 236), the touch screen control module 18 (FIG. 2) sends a double click output 42 to the system processor 12. Following step 240, the triple click validation process is stopped and control returns to step 200. Alternatively, if at step 238, the second touch event location is inside of the triple click box, flow passes to FIG. 4C.

In FIG. 4C, at step 242, the second release event is analyzed to determine whether the second release event is inside of the triple click box. If no, flow passes to step 244. At step 244, the micro-controller 30 (FIG. 2) determines whether the double click flag was set at step 236 and if so a double click output command 42 is sent to the system processor 12. Following step 242, the triple click validation process is stopped and control returns to step 200.

At step 242, if the second release event is determined to be inside of the triple click box, flow passes to step 246 at which the timer module 36 (FIG. 2) is reset. At step 248, the micro-controller 30 searches for a third touch event (3^{rd} T/E). If a third touch event does not occur before the timer times out, flow passes to step 250. At step 250, if the double click flag has been set, a double click output 42 is passed to the system processor 12. Alternatively, if the micro-controller 30 detects a third touch event at step 238, before the timer times out flow passes to step 252 in FIG. 4D.

In FIG. 4D, at step 252, the micro-controller 30 determines the position of the third touch event. At step 254, it is determined whether the third touch event is inside of the triple click box. If not, flow passes to 256, at which it is determined whether a double click flag was set. If a double click flag was set then at step 256, a double click output 42 is passed to the system processor 12. At step 258, a “left button down” status (e.g., output 38) and the location of the left button down status is passed to the system processor 12. The triple click validation process is stopped following step 258.

Alternatively, if at step 254, the comparator module 34 determines that the third touch event is inside of the triple click box, flow passes to step 260. At step 260, the micro-controller 30 searches for the third release event (3^{rd} R/E). If the third release event does not occur before the timer times out, flow returns to step 256. If the third release event occurs before the timer times out, flow passes to step 262, at which the comparator module 34 determines whether the third release event is inside of the triple click box. If the third release event is not inside the triple click box, flow passes to step 264, at which the micro-controller determines whether the double click flag was set, and if so a double click output command 42 is sent to the system processor 12. Following step 264, the triple click validation process is stopped.

Returning to step 262, if the third release event is determined to be inside of the triple click box, flow passes to step 266, at which a valid triple click input action is identified. In the exemplary embodiment, a triple click input action is associated with a computer mouse right click output 40. Thus, at step 266, a right click input output 40 is sent to the system processor 12.

It is understood that the above processing steps are only exemplary and may be performed in different orders, may be replaced with alternative equivalent operations removed entirely and the like. Optionally, the triple click validation process may output a command other than a right click computer mouse command. As a further option, more than three consecutive touch and release events may be searched for in connection with a valid right button mouse click. Optionally, in addition or in replace of touch or release events, a drag event my be used. In a drag event, the user touches the screen and drags a finger along the screen, such as in a drag and drop operation.

Optionally, the triple click box associated with the touch event may not be coextensive with the triple click box associated with release events. Instead, partially overlapping or separately distinct triple click boxes may be associated with one or more of the touch events and one or more of the release events.

While the invention has been described in terms of various specific embodiments, those skilled in the art will recognize that the invention can be practiced with modification within the spirit and scope of the claims.

What is claimed is:

1. A method for providing user-selectable functionality through a touch screen, comprising:
defining an active area on the touch screen, said active area being associated with at least one functional set;
detecting input actions at the touch screen, each said input action being defined by at least one of a touch event and a release event at the touch screen;
determining when a series of at least three input actions occurs within a common active area; and
producing an operation command based on a number of said input actions in said series and based upon said common active area in which said series of said at least three input actions occurred, said operation command being associated with said at least one functional set.

2. The method of claim 1, wherein said operation command corresponds to a right-click on a personal computer mouse.

3. The method of claim 1, further comprising assigning different first and second *functional sets to said common active area corresponding to first and second operation commands, respectively.

4. The method of claim 1, said detecting including sensing said touch event based on an object contacting the touch screen.

5. The method of claim 1, said detecting including identifying a touch event when an object is positioned proximate to the touch screen.

6. The method of claim 1, wherein each said input action is defined based on said touch event followed by said release event.

7. The method of claim 1, said detecting comprising sensing said touch event and initiating a timer, wherein said release event must occur within a predetermined time interval defined by said timer to constitute a valid input action.

8. The method of claim 1, said detecting comprising sensing both said touch event and said release event, and determining whether said touch and release events occur in said common active area.

9. The method of claim 1, further comprising determining when first, second and third input actions occur within predefined time intervals of one another.

10. The method of claim 1, further comprising setting a timer interval in which consecutive touch events must occur to constitute said input action.

11. The method of claim 1, further comprising determining when a first touch event occurs in said common active area and a corresponding first release event occurs outside said common active area.

12. A touch screen system, comprising:
a touch screen presenting information indicative of an active area, said active area being associated with at least one functional set;
a sensor unit proximate to said touch screen sensing at least one of a touch event and a release event defining an input action; and
a processor determining when a series of at least three input actions occurs within a common active area, said processor producing an operation command based on a number of said input actions in said series and upon said common active area, said operation command being associated with said at least one functional set.

13. The touch screen system of claim 12, wherein said operation command responds to a right click on a personal computer mouse.

14. The touch screen system of claim 12, wherein said processor assigns different first and second functional sets to said common and active area corresponding to first and second operation commands, respectively.

15. The touch screen system of claim 12, wherein said sensor input senses said touch event based on an object contacting said touch screen.

16. The touch screen system of claim 12, wherein said processor identifies said touch event when an object is positioned proximate to the touch screen.

17. The touch screen system of claim 12, wherein each said input action is defined based on said touch event followed by said release event.

18. The touch screen system of claim 12, wherein said processor initiates a timer upon sensing the touch event, wherein said release event must occur within a predetermined time interval defined by said timer to constitute a valid input action.

19. The touch screen system of claim 12, wherein said sensor unit senses both said touch event and said release event, and said processor determines whether the touch and release events occur in said common active area.

20. The touch screen system of claim 12, wherein said processor determines when first, second and third input actions occur within predefined time intervals of one another.

21. The touch screen system of claim 12, wherein said processor sets a timer interval in which consecutive touch events must occur to constitute said input action.

22. The touch screen system of claim 12, wherein said processor determines when a first touch event occurs in said common active area and a corresponding first release event occurs outside said common active area.

23. An electronic device, comprising:
a display screen presenting information indicative of active areas to a user, each of said active areas being associated with at least one functional set;
a sensor unit proximate to the display screen sensing input actions defined by at least one of a touch event and a release event;
a timer setting a maximum time interval in which valid consecutive touch events shall occur to constitute part of a series of input actions; and
a processor determining when a series of at least three input actions occur based on said timer interval, said processor producing a triple-click operation command when the series of at least three input actions occurs within said timer intervals.

24. The electronic device of claim 23, wherein said processor produces said triple-click operations command based on a position of said input actions relative to said active areas.

25. The electronic device of claim 23, wherein said processor assigns different first and second functional sets to one said active area corresponding to a double-click operation command and said triple-click operation command, respectively.
